(19) United States
(12) Patent Application Publication
(10) Pub. No.: US 2009/0012881 A1
(43) Pub. Date: Jan. 8, 2009

(54) SYSTEM AND METHOD FOR IMPROVED MANAGEMENT OF SELLER LISTINGS ON E-COMMERCE WEBSITES

(75) Inventors: Brian Popelka, Salt Lake City, UT (US); Eyad G. Haddadin, Salt Lake City, UT (US)

Correspondence Address: ALAN J. HOWARTH, P.O. BOX 1909, SANDY, UT, 84091-1909, US

(73) Assignee: OVERSTOCK.COM, INC., Salt Lake City, UT (US)

(21) Appl. No.: 12/171,140

(22) Filed: Jul. 10, 2008

Related U.S. Application Data
(63) Continuation of application No. 12/001,058, filed on Dec. 6, 2007, now abandoned.
(60) Provisional application No. 60/873,808, filed on Dec. 7, 2006.

(51) Int. Cl. G06Q 30/00

(52) U.S. Cl. 705/27

(57) ABSTRACT

A system and method providing improved management of product listings on an e-commerce website by allowing sellers to define rules or conditions that automatically adjust a product's listing price based upon a triggering event. The triggering event may be the expiration of a pre-defined time period. The listing price of a product can be automatically reduced in the event that the product does not sell within a certain time frame. Further, sellers are immediately notified of an offer to purchase a listed product.

### CROSS-REFERENCE TO RELATED APPLICATIONS

This application is a continuation of co-pending U.S. patent application Ser. No. 12/001,058, filed Dec. 6, 2007, which claims the benefit of U.S. Provisional Application No. 60/873,808, filed Dec. 7, 2006, which are hereby incorporated by reference herein in their entireties, including but not limited to those portions that specifically appear hereinafter, the incorporation by reference being made with the following exception: In the event that any portion of the above-referenced applications are inconsistent with this application, this application supercedes said above-referenced applications.

### STATEMENT REGARDING FEDERALLY SPONSORED RESEARCH OR DEVELOPMENT

Not Applicable.

### BACKGROUND

1. The Field of the Invention

The present disclosure relates generally to managing products listed on e-commerce websites, and more particularly, but not necessarily entirely, to allowing sellers to define automatic adjustment of listing prices of products listed on e-commerce websites and notifying sellers of offers by prospective buyers.

2. Description of Related Art

Sellers have long been able to list items for sale on websites hosted by others. Popular sites include auction websites. Typically, the seller uploads its product information to the host's websites. The product information may include a description of the product, an asking price, and digital images of the product. Sellers typically list multiple items on a single host's website.

In the past, management of a seller's listings on a host's website has been fairly limited. For example, a seller has had little ability to manage inventory and listing prices other than manually logging onto the site and changing the information on a listing-by-listing basis. Further, the seller has had little or no ability to use automated features to automatically adjust listing prices in the event that a product remains unsold for a pre-defined period of time. For example, it would be beneficial to provide the seller with computerized management tools to define conditions under which a listing price for a product would be lowered if a product remains unsold for more than a pre-specified period of time. In this manner, the seller's management burden would be eased, especially where the seller has multiple listings.

In the past, online sellers have lost prospective buyers due to the inability to receive timely notice of an offer to purchase a product. It would be an advancement over the prior art to improve notification to sellers of prospective buyers' offers made through an e-commerce site.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a diagram of a computing device suitable for use with the present invention;

FIG. 2 is a diagram of one embodiment of the present invention;

FIG. 3 is a diagram of one embodiment of a server suitable for use with the present invention;

FIG. 4 is an exemplary screenshot of one illustrative embodiment of the present invention;

FIG. 5 is an exemplary screenshot of one illustrative embodiment of the present invention;

FIG. 6 is an exemplary screenshot of one illustrative embodiment of the present invention;

FIG. 7 is an exemplary screenshot of one illustrative embodiment of the present invention;

FIG. 8 is an exemplary screenshot of one illustrative embodiment of the present invention;

FIG. 9 is an exemplary screenshot of one illustrative embodiment of the present invention; and

FIG. 10 is an exemplary screenshot of one illustrative embodiment of the present invention.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method steps.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment” or “illustrative embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Reference to a computer program may take any form capable of generating a signal, causing a signal to be generated, or causing execution of a program of machine-readable instructions on a digital processing apparatus. A computer program may be embodied by a transmission line, an optical storage medium, digital-video disk, a magnetic tape, a Bernoulli drive, a magnetic disk, a punch card, flash memory, integrated circuits, or other digital processing apparatus memory device.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

Applicants have discovered a system and method for facilitating the management and control of a seller's listings on an e-commerce website. Applicants' invention allows sellers to pre-define price adjustments to the asking price or invoice price of products listed on an e-commerce site based upon the occurrence of a triggering event. In one embodiment, the triggering event is the expiration of a specified time period. The use of pre-defined price adjustments, which adjustments may occur at some future date, allows a seller to automatically modify the price of a product listing in the event that the product remains unsold. In this manner, the seller is relieved of the burden of manually adjusting the price of items that remain unsold on the e-commerce website.

A further aspect of the present invention is the ability to immediately notify a seller of an offer to purchase a product listed on an e-commerce website.

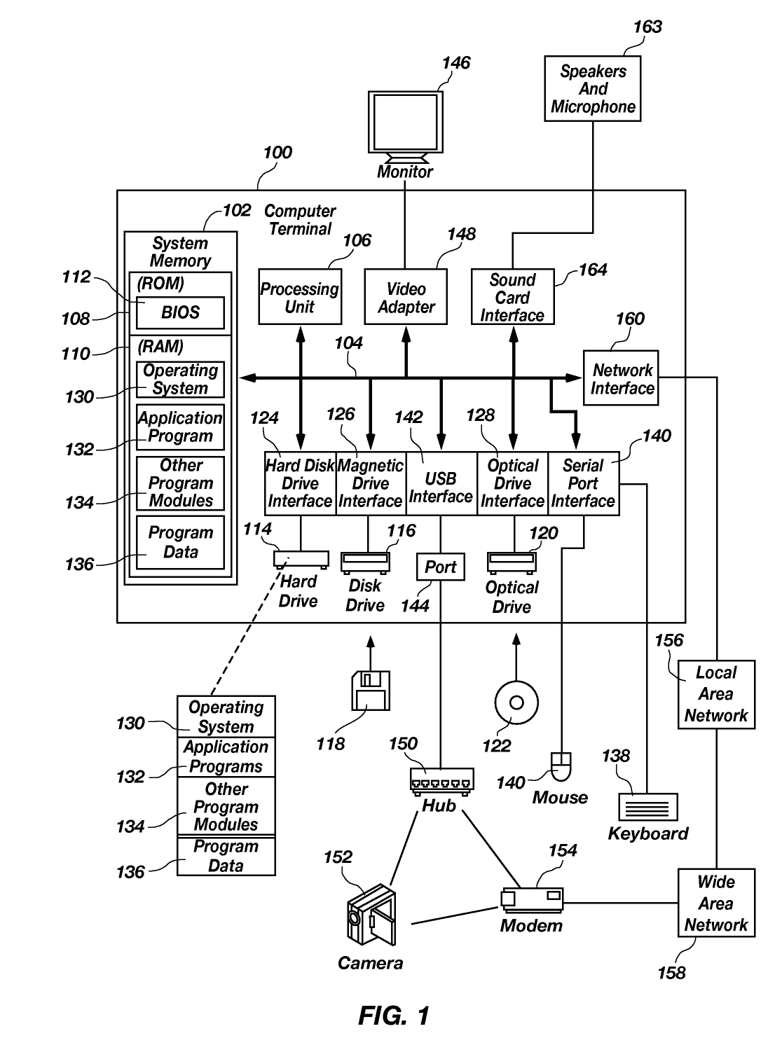

Referring now to FIG. 1, there is shown an exemplary embodiment of a computer 100, that may be used for the computing devices used in the present disclosure. It will be appreciated that the computing devices may have more or fewer features than shown in FIG. 1 as the individual circumstances require. Further, the computer 100 shown in FIG. 1 may have various forms, including a desktop PC, a laptop or a portable tablet form, or a hand held form. The features shown in FIG. 1 may be integrated or separable from the computer 100. For example, while a monitor 146 is shown in FIG. 1 as being separate, it may be integrated into the computer 100, such as the case of a laptop or tablet type computer.

The computer 100 may include a system memory 102, and a system bus 104 that interconnects various system components including the system memory 102 to the processing unit 106. The system bus 104 may be any of several types of bus structures including a memory bus or memory controller, a peripheral bus, and a local bus using any of a variety of bus architectures as is known to those skilled in the relevant art. The system memory may include read only memory (ROM) 108 and random access memory (RAM) 110. A basic input/output system (BIOS) 112, containing the basic routines that help to transfer information between elements within the computer 100, such as during start-up, is stored in ROM 108. The computer 100 may further include a hard disk drive 114 for reading and writing information to a hard disk (not shown), a magnetic disk drive 116 for reading from or writing to a removable magnetic disk 118, and an optical disk drive 120 for reading from or writing to a removable optical disk 122 such as a CD ROM, DVD, or other optical media.

It will be appreciated that the hard disk drive 114, magnetic disk drive 116, and optical disk drive 120 may be connected to the system bus 104 by a hard disk drive interface 124, a magnetic disk drive interface 126, and an optical disk drive interface 128, respectively. The drives and their associated computer-readable media provide nonvolatile storage of computer readable instructions, data structures, program modules and other data for the computer 100. Although the exemplary environment described herein employs a hard disk, a removable magnetic disk 118, and a removable optical disk 122, it will be appreciated by those skilled in the relevant art that other types of computer readable media which can store data that is accessible by a computer, such as magnetic cassettes, flash memory cards, digital video disks, Bernoulli cartridges, random access memories, read only memories, and the like may also be used in the exemplary operating environment.

A number of program modules may be stored on the hard disk 114, magnetic disk 118, optical disk 122, ROM 108 or RAM 110, including an operating system 130, one or more applications programs 132, other program modules 134, and program data 136. A user may enter commands and information into the computer 100 through input devices such as a keyboard 138 and a pointing device 140, such as a mouse. Other input devices (not shown) may include a joystick, game pad, satellite dish, scanner, or the like. These and other input devices are often connected to the processing unit 106 through a serial port interface 140 that is coupled to the system bus 104. Increasingly, such devices are being connected by the next generation of interfaces, such as a universal serial bus (USB) interface 142 with a USB port 144, and to which other hubs and devices may be connected. Other interfaces (not shown) that may be used include parallel ports, game ports, and the IEEE 1394 specification.

A monitor 146 or other type of display device is also connected to the system bus 104 via an interface, such as a video adapter 148. In addition to the monitor 146, computers 100 typically include other peripheral output or input devices. For example, an ultra slim XGA touch panel may be used. A resistive finger touch screen may also be used.

A USB hub 150 is shown connected to the USB port 144. The hub 150 may in turn be connected to other devices such as a digital camera 152 and modem 154. Although not shown, it is well understood by those having the relevant skill in the art that a keyboard, scanner, printer, external drives (e.g., hard, disk and optical) and a pointing device may be connected to the USB port 144 or the hub 150. Thus, it should be understood that additional cameras and devices may be directly connected to the computer through the USB port 144. Thus, the system depicted is capable of communicating with a network and sending/receiving audio, video and data.

The computer 100 may operate in a networked environment using logical connections to one or more remote computers. The types of connections between networked devices include dial up modems, e.g., modem 154 may be directly used to connect to another modem, ISDN, xDSL, cable modems, wireless and include connections spanning users connected to the Internet. The remote computer may be another personal computer, a server, a router, a network PC, a peer device or other common network node, and typically includes many or all of the elements described above relative to the computer 100 in FIG. 1. The logical connections depicted in FIG. 1 include a local area network (LAN) 156 and a wide area network (WAN) 158. Such networking environments are commonplace in offices, enterprise-wide computer networks, intranets and the Internet.

When used in a LAN networking environment, the computer 100 is connected to the local network 156 through a network interface or adapter 160. The computer 100 may also connect to the LAN via through any wireless communication standard, such as the 802.11 wireless standard. When used in a WAN networking environment, the computer 100 typically uses modem 154 or other means for establishing communications over the wide area network 158. It should be noted that modem 154 may be internal or external and is connected to the system bus 104 through USB port 144. A modem may optionally be connected to system bus 104 through the serial port interface 140. It will be appreciated that the network connections shown are exemplary and other means of establishing a communications link between the computers may be used, e.g., from a LAN gateway to WAN.

The computer 100 may also receive audio input from a microphone and output audio sounds through speakers as illustratively shown by the box marked with the reference numeral 162 in FIG. 1. A sound card interface 164 processes the sounds to a sound card and the system bus 164. Further, the computer 100 may take many forms as is known to those having relevant skill in the art, including a desk top personal computer, a lap top computer, a hand held computer, and the like. Further, the computer compatibility of the computer 100 may include, without limitation, IBM PC/XT/AT, or compatibles, or Apple Macintosh. The operating system 130 compatibility may include, without limitation, MS-DOS, MS-Windows, Unix, or Macintosh.

Generally, the data processors of computer 100 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The disclosure described herein includes these and other various types of computer-readable storage media when such media contain instructions or programs for implementing the steps described herein in conjunction with a microprocessor or other data processor. The disclosure also includes the computer itself when programmed according to the methods and techniques described herein.

The computer 100 may have loaded into memory a web browser, which is an application program that provides a way to look at and interact with all the information on the World Wide Web. Netscape and Microsoft Internet Explorer are examples of two types of browsers that may be used. Firefox is another example.

A server may also take substantially the same form as the computer 100 shown in FIG. 1. The server, in its simplest form, is a computer that stores Web documents and makes them available to the rest of the world over the World Wide Web. The server may be dedicated, meaning its sole purpose is to be a server, or non-dedicated, meaning it can be used for basic computing in addition to acting as a server. In one embodiment, the main body of software used with the present disclosure resides on the web server. Software may also reside on other terminals as needed or desired.

The computer 100 may be directly connected to a power source, such as AC power, or comprise a battery for allowing portable operation. The computer 100 may also include other features not explicitly shown in FIG. 1, including expansion slots for adding additional hardware to the terminal 100 and I/O ports which may include RJ-11 modem, RJ-45 fast ethernet ports, USB ports, IEEE 1394 ports, headphone jack, microphone jack, and a VGA port. Additional features of the terminal also not explicitly shown may include short-cut buttons, a wheel key, a power switch and a wireless LAN On/Off switch.

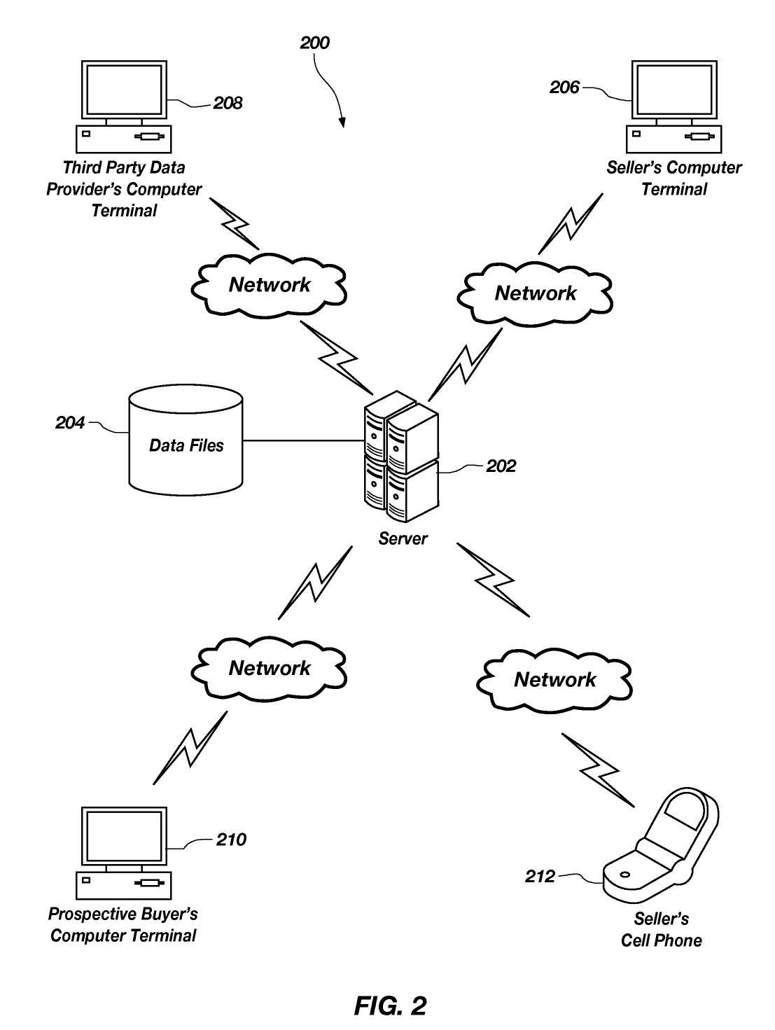

Referring now to FIG. 2, there is shown a system 200 pursuant to one embodiment of the present disclosure for allowing e-commerce between buyers and sellers via a third party website hosted on a server 202. As used herein, the term “e-commerce” refers to the buying and selling of goods and services on the Internet or the offer to buy or sell goods and services on the Internet. In one embodiment, the server 202 is operated and controlled by a third party that is not the seller or buyer of the goods or services. This third party may be referred to herein as the “Website Operator.” It will be noted however, that the buyer or seller may be the operator and/or controller of the server 202 and its related applications as described herein.

The Website Operator provides a service to allow sellers and buyers to engage in e-commerce using its server 202. The Website Operator may charge the sellers and/or buyers for use of the server 202. Typically, numerous sellers may offer their goods through the server 202 to create an online marketplace. Numerous buyers may also access the server 202 as well. Access to server 202 by buyers and/or sellers may be through a login procedure as is known to one having ordinary skill in the art. The use of the server 202 allows sellers, who do not desire the hassles of managing their own websites, to have a presence on the Internet.

The server 202 is connected to an electronic storage medium 204. Residing on the storage medium 204 is data related to seller's products or services, hereinafter referred to generally as Product Information. The Product Information may be uploaded directly from a seller's computer terminal 206 over a network. Alternatively, the Product Information may be uploaded from a third party data provider's computer terminal 208 over a network. The third party data provider may have a relationship with seller to provide the Product Information to an e-commerce website to relieve the seller of this responsibility. For example, in the case where the seller is an auto dealer, the auto dealer may contract with the third party data provider to provide the Product Information, which, in this case, would be information regarding the automobiles offered by the seller. In one embodiment, the Product Information on the storage medium 204 may be stored in a database format.

The Product Information may include any information typically necessary to sell the product. For example, where the product is an automobile, the Product Information may include, without limitation, the asking price, invoice price, vehicle identification number, condition, warranty information, color, stock number, location, year, make, model, milage, and features of the automobile. The Product Information may also include electronic images of the automobile or electronic links to files where the electronic images may be found and retrieved. The Product Information is uploaded in a manner such that the Product Information is associated with the seller. The Product Information may be updated as often as is necessary over a network, including, without limitation, daily, weekly and monthly.

The seller may also be allowed remote access to server 202 after the Product Information has been uploaded in order to allow the seller to manage its listings. In one embodiment, the seller is allowed access from the seller's terminal 206 over a network. In another embodiment, the seller is allowed access from any other computing device connected to server 202 over a network, such as the Internet. The seller is granted certain rights by the server 202 to manage the Product Information. Further, the seller may take advantage of certain features offered through the server 202 to increase sales. These features, which will be discussed hereinafter, are novel features not found in any of the previously available e-commerce websites.

The server 202 may provide webpages to a prospective buyer's terminal 210 when requested over a network. The webpages may provide the necessary Product Information to the prospective buyer. The webpages may also allow the buyer to search, place a bid, make an offer, request additional information or purchase the product at the asking price. The webpages may also allow the buyer to send a message directly to the seller as will be discussed hereinafter. The webpages may allow for advanced searching of the products offered through server 202 by sellers.

As mentioned, the server 202 may allow a prospective buyer to send a communication to the seller. For example, the prospective buyer, via the buyer's terminal 210, may make an offer below the asking price of a product. The server 202 receives this offer and immediately disseminates the buyer's offer to the seller. In one embodiment, the server 202 sends an electronic message to the seller's computer terminal 206. In another embodiment, the server 202 sends an electronic message, such as a text message, to a portable electronic device, such as a seller's cell phone 212. Thus, server 202 includes a computer program for transmitting these messages to seller's terminal 206 and/or cell phone 212 using the appropriate method.

It will be appreciated by those having ordinary skill in the art that the server 202, the seller's computer terminal 206, the third party data provider's terminal 208, and the prospective buyer's computer terminal 210 may take the form of terminal 100 discussed in relation to FIG. 1 above. Moreover, the server 202 may also take the form of any host computer on a network that holds information and responds to requests for information from it. It should be noted that the term “server” as used herein is also used to refer to the software that makes the act of serving information possible. The term “server” also refers to commerce servers, for example, that use software to run the main functions of an e-commerce Website, such as product display, online ordering, and inventory management. The term “server” as used herein also refers to application servers, web servers, database servers, and so forth necessary to carry out the present disclosure as is known to one having ordinary skill in the art.

Further, as alluded to above, the storage medium 204 stores information and applications used by server 202 to provide the features described herein. This may include webpages to be served to client computers and data regarding e-commerce, including product and sales information. It should understood that the storage medium 204 may be utilized to store any information and/or computer applications necessary to carry out the present invention. The networks referred to herein may include any data communications system which interconnects computer systems at various different sites. A network may be composed of any combination of LANs, or WANs. A network may be the Internet.

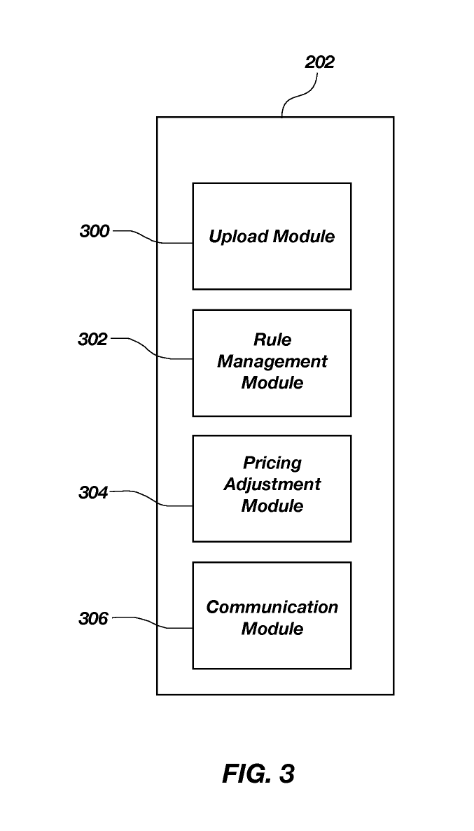

Referring now to FIG. 3, there are shown various modules that may be associated with the server 202. The server 202 may include an upload module 300. The upload module 300 allows Product Information to be uploaded to the server 202 and stored in the storage medium 204 by the seller or the seller's agent. The Product Information may be uploaded pursuant to a previously designated protocol between the seller and the Website Operator. In one embodiment, the Product Information is sent in a comma separated data file. Addresses to digital images of the products may also be uploaded to server 202 in the comma separated data file to allow for later retrevial.

A rule management module 302 allows the seller to manage the uploaded data pertaining to the Product Information. For example, the seller may be able to change the Product Information. The seller may be able to remove listed items, modify or otherwise manage the Product Information.

In addition to the above, the rule management module 302 also allows the seller to optionally define rules to automatically change, vary or adjust the price of a listed product based upon pre-defined conditions set by the seller. The adjustment to the price of the listed product may be a price markup or a price markdown. Typically, the rules set by the seller allow the automatic lowering of the listed price when a product has been listed for a predetermined amount of time. The rules may allow for successive and multiple decreases in the listing price after the expiration of time periods set by the seller. The adjustments to the listing price may be defined as a percentage amount or in dollar amounts.

In one embodiment, the rule management module 302 allows a seller to define a rule to lower the listing price by a certain percentage amount after the lapse of successive time periods defined by the seller. For example, the seller is able to define a rule to automatically lower the listing price by 10% after the product has been listed for thirty (30) days. The seller could further define the rule to automatically lower the listing price an additional 15% after the end of forty-five (45) days. The seller could still further define the rule to automatically lower the listing price an additional 25% after the end of sixty (60) days. The time periods are typically measured from the date the product was first listed.

In another embodiment, the rule management module 302 allows a seller to define a rule to lower the listing price a pre-specified dollar amount after the lapse of each time period defined by the seller. For example, the seller is able to define a rule to automatically lower the listing price by $100.00 after the product has been listed for thirty (30) days. The seller is able to further define the rule to automatically lower the listing price an additional $150.00 after the end of forty-five (45) days. The seller could still further define the rule to automatically lower the listing price an additional $250.00 after the end of sixty (60) days. In this manner, the listing price of the product is automatically lowered until it sells.

In still another embodiment, the rule management module 302 allows a seller to define a rule to change or modify the mark-up price over an invoice price after the lapse of time periods defined by the seller. Using this aspect of the invention, the seller is able to define a rule to automatically mark-up an invoice price until the expiration of a pre-determined time period. At the end of the pre-determined time period, the markup price may be reduced to thereby lower the asking price for the product.

For example, the seller may define a rule to automatically markup a product's price by 25% over the invoice price for the first thirty (30) days that the product is listed. At the end of the first thirty (30) days, the rule may define that the product's price be marked up 15% over the invoice price. At the end of the first forty-five (45) days, the rule may further specify that the product's price be marked up only 10% over the invoice price. In this manner, the product's listed price is automatically, and without further action by the seller, reduced.

Likewise, in still another embodiment, the seller is able to define a rule to automatically markup a product's price by $250.00 over the invoice price for the first thirty (30) days that the product is listed. At the end of the first thirty (30) days, the rule may define that the product's price be marked up only $150.00 over the invoice price. At the end of the first forty-five (45) days, the rule may further specify that the product's price be marked up only $100.00 over the invoice price. In this manner, the listing price is reduced until the item is sold or removed from the listing.

The rule management module 302 may include a feature to prevent the seller from overpricing the product through excessive markup. For example, the rule management module 302 may prevent the seller from marking up a product's listing price over the MSRP of the product or a cap previously set by the seller.

Each rule established by the seller is dependent upon at least one triggering event or condition to cause the automatic price adjustment. In one embodiment of the present disclosure, the triggering event is an expiration of a time period as discussed above. It will be appreciated that this allows the reduction in price of products which have been sitting too long in the seller's inventory. Triggering events may also be dependent upon other factors defined by the seller, including, without limitation, inventory amount, market demand, web clicks and time of year. It should be noted that the seller can establish a global rule set for all or a portion of its listed products. Further, the seller may establish a rule set for its listed products on a product-by-product basis or even a class of products. For example, in the case of an automobile dealer, the dealer may establish different rule sets for each car manufacturer and/or model of car.

The rule management module 302 may provide templates to facilitate the rule management process by the seller. The templates allow the seller to easily and quickly define a rule set and triggering events. The templates may be stored on storage medium 204 and served to seller in association with webpages when so requested. The templates may easily allow the automatic price adjustment pursuant to a pre-determined rate, such as linearly or non-linearly, over commonly used time periods.

The pricing adjustment module 304 implements the rules established by the sellers to thereby automatically effectuate changes in the product pricing. The pricing adjustment module 304 monitors the triggering events for each rule. When a triggering event has occurred, the pricing adjustment module 304 automatically, and independent of any further input from the seller, adjusts the product's price according to the rule established by the seller. The pricing adjustment module 304 loops continuously so that once a rule has been established and enabled, no further action is needed by the seller to implement the rule.

The communication module 306 is operable to inform a seller that an offer has been recently submitted by a prospective buyer. When the prospective buyer enters an offer at the buyer's terminal 210, the offer is transmitted over a network to the server 202. The communication module 306 then immediately sends the offer to the seller's terminal 206 and/or the seller's cell phone 212. The communication module 306 may use e-mail or text messaging to automatically send notification about the offer to the seller. In this manner, the seller does not have to wait to check the seller's terminal 206 to learn that an offer has been submitted because the information regarding the buyer's offer is immediately sent to the seller's cell phone 212.

In one embodiment, the communication module 306 prepares and formats the message to the seller using the short message service (“SMS”). SMS is a service available on most digital mobile phones (and other mobile devices, e.g. a Pocket PC, or occasionally even desktop computers) that permits the sending of short messages (also known as text messages, or more colloquially SMSes, texts or even txts) between mobile phones, other handheld devices and even landline telephones. Messages are sent to a Short Message Service Centre (“SMSC”) which provides a store-and-forward mechanism. The SMSC attempts to send messages to their recipients. If a recipient is not reachable, the SMSC queues the message for later retry. Some SMSCs also provide a “forward and forget” option where transmission is tried only once.

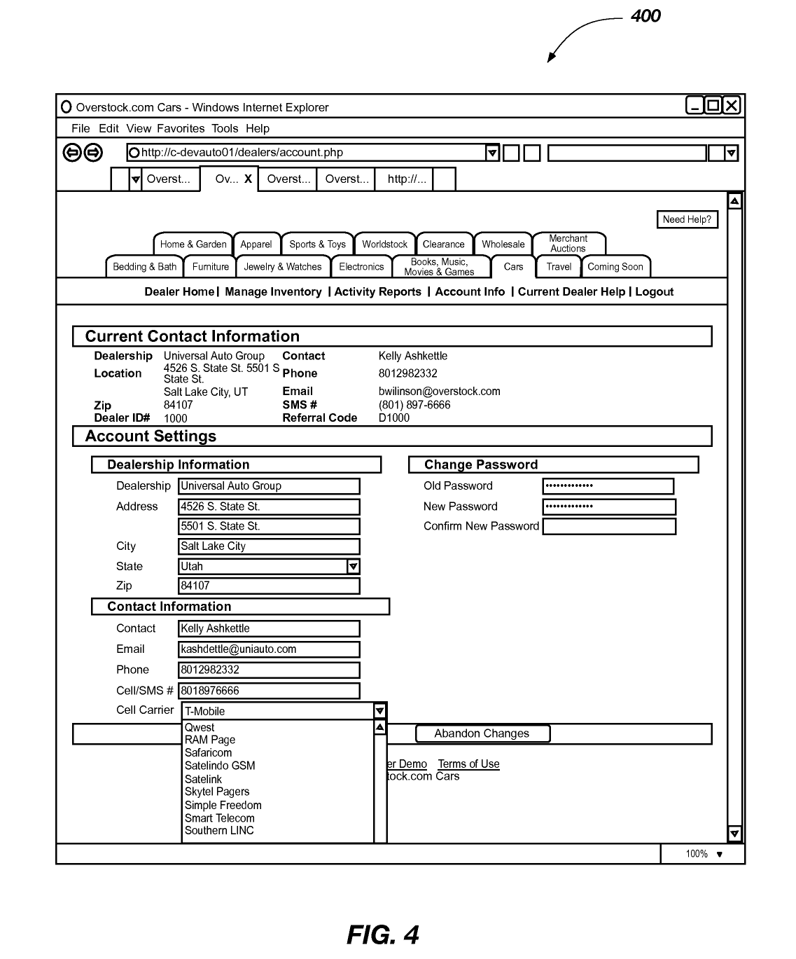

Referring now to FIG. 4, there is shown one exemplary screenshot 400. Screenshot 400 depicts an interface for allowing a seller's information to be entered on server 202. In this case, the seller is an automobile dealer. The seller is able to enter dealership information. The seller is also able to input contract information, including a contact person, email address, phone number and cell phone number. The seller must also specify the cell carrier for the cell phone number. The cell phone carrier information is used by the server 202 to notify the contact person of a buyer's offer to purchase a product.

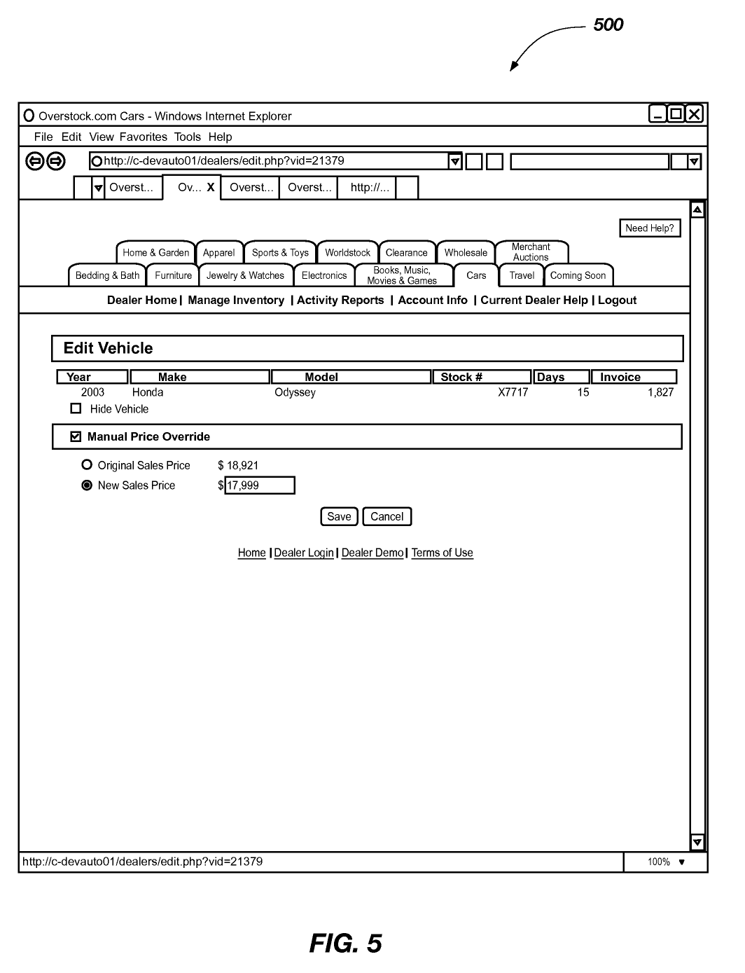

Referring now to FIG. 5, there is shown one exemplary screenshot 500. Screenshot 500 depicts an interface for allowing a seller to manually override the price of a product listed on server 202.

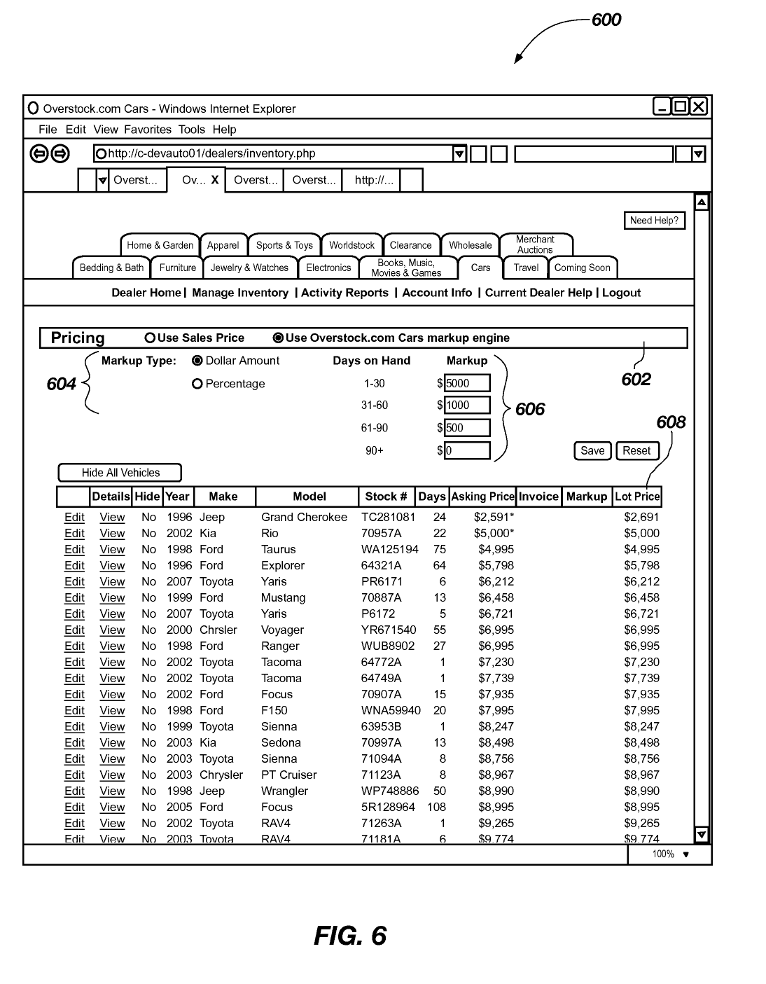

Referring now to FIG. 6, there is shown one exemplary screenshot 600. Screenshot 600 depicts an interface for allowing a seller to manage its product listings. The seller is given the option to use a product price adjustment feature as depicted in bar 602. The seller is further given the option to select a markup type, in this case, either dollar amount or a percentage amount as depicted by bracket 604. A template 606 allows a seller to enter a markup for “Days On Hand.” In this case, the markup is applied to an invoice price. Thus, the longer the automobile is listed, the lower the price will become. A table 608 displays information about the listed products, including: an edit link, a details link, a hide status indicator, a year, make, model, stock number, days listed, asking price, invoice price, markup, and lot price.

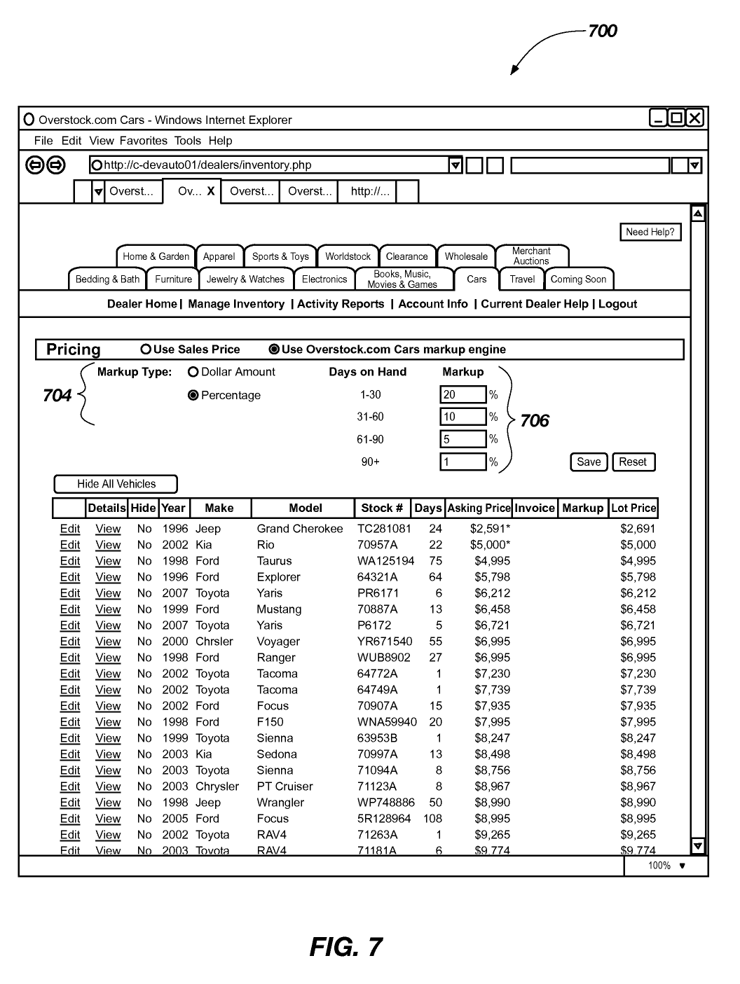

Referring now to FIG. 7, there is shown one exemplary screenshot 700. Screenshot 700 depicts an interface for allowing a seller to manage its product listings. In this case, the seller has selected a markup amount by percentage as shown in th markup type 704. The seller can specify a markup percentage for the “Days On Hand” as shown by template 706. Because the percentage decreases, the price on an automobile will decrease since the markup is based upon the invoice price.

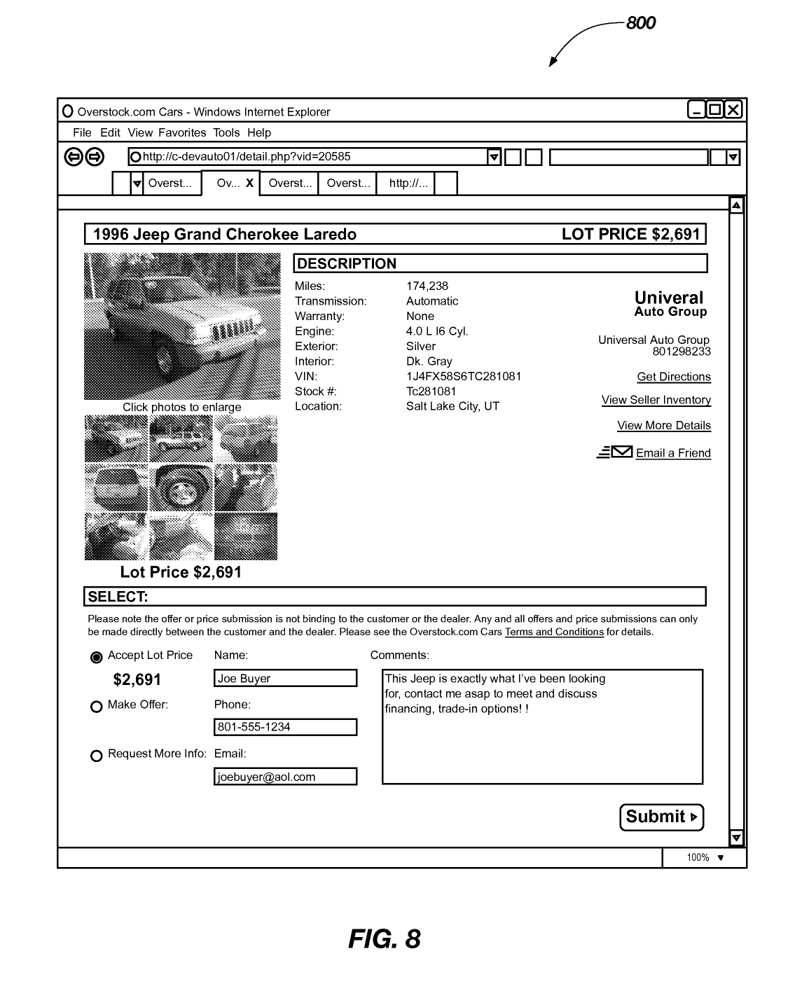

Referring now to FIG. 8, there is shown one exemplary screenshot 800. Screenshot 800 depicts an interface for allowing a buyer to view Product Information. The interface also allows a buyer three options: Accept Lot Price, Make Offer, and Request More Info. In FIG. 8, the Accept Lot Price option has been selected. This means that the buyer wants to purchase at the listed price. The buyer may also enter contact information and enter comments for the seller. When the buyer has selected one of the three options and entered the appropriate information and then clicks the “Submit” button, the information is sent to the seller via the server 202. The information is sent to the seller's cell phone and email account using the information entered in relation to FIG. 4.

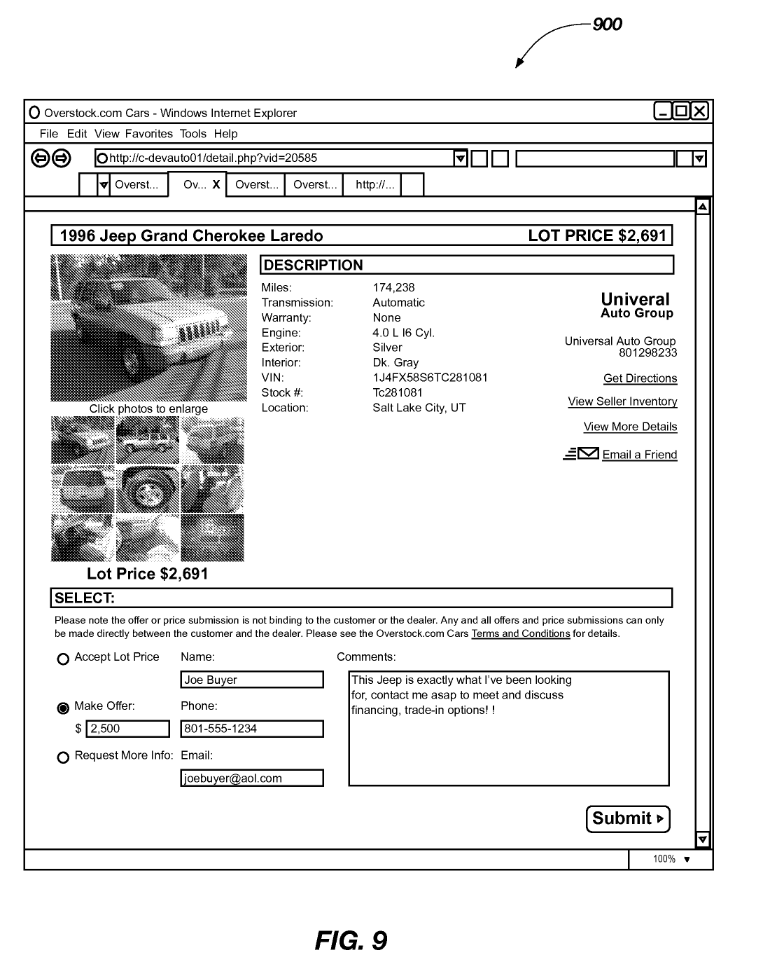

Referring now to FIG. 9, there is shown one exemplary screenshot 900. Screenshot 900 depicts an interface for allowing a buyer to view Product Information. The interface also allows a buyer three options: Accept Lot Price, Make Offer, and Request More Info. In FIG. 9, the Make Offer option has been selected and the buyer has entered an offer in the amount of $2500. Again, when the “Submit” button is clicked, this information is sent to server 202, which in turns sends the information to the seller's email account and cell phone.

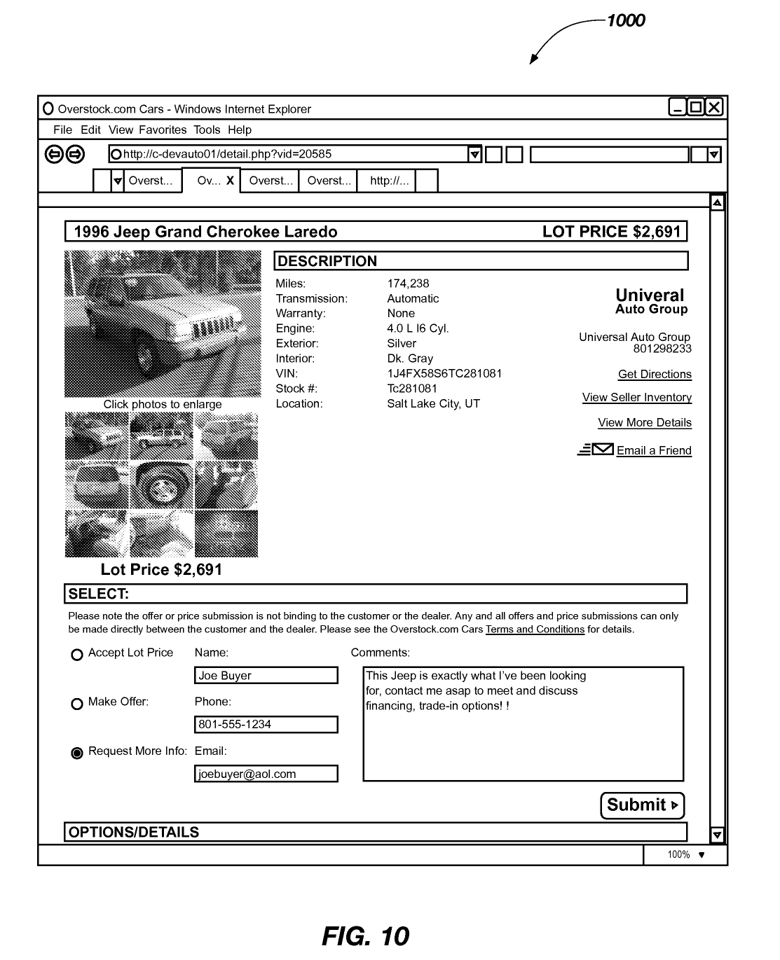

Referring now to FIG. 10, there is shown one exemplary screenshot 1000. Screenshot 1000 depicts an interface for allowing a buyer to view Product Information. The interface also allows a buyer three options: Accept Lot Price, Make Offer, and Request More Info. In FIG. 10, the Request More Info option has been selected. Again, when the “Submit” button is clicked, this information is sent to server 202, which in turns sends the information to the seller's email account and cell phone.

Those having ordinary skill in the relevant art will appreciate the advantages provide by the features of the present disclosure. For example, it is a feature of the present disclosure to provide an improved system and method for sellers to manage listings on e-commerce websites. Another feature of the present disclosure to provide sellers with improved notification of an offer to purchase an item listed on an e-commerce website.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method for allowing a seller to manage products listed on an e-commerce website, said method comprising the steps of:
receiving product information in a digital format, the product information identifying at least one product for sale and an associated price;
providing a framework whereby the seller may define a pricing adjustment rule and an associated triggering event;
storing the pricing adjustment rule and the triggering event defined by the seller in an electronic storage medium; and
implementing the pricing adjustment rule based upon an occurrence of the triggering event to thereby cause an automatic adjustment of the price of the product.

2. The method of claim 1, wherein the price is an asking price and the pricing adjustment rule defines one or more markdowns of the asking price.

3. The method of claim 1, wherein the price is an invoice price and the pricing adjustment rule defines one or more markups of the invoice price.

4. The method of claim 1, wherein the triggering event is the expiration of one or more time periods.

5. The method of claim 1, wherein the product for sale is an automobile.

6. The method of claim 1, wherein the framework comprises pre-defined templates.

7. A method for offering products for sale on an e-commerce website, said method comprising the steps of:
storing product information regarding the products in an electronic storage medium, the product information identifying the products for sale and an asking price associated with each product;
listing the products for sale on the e-commerce website at their respective asking prices; and
implementing a pre-defined and automated procedure for adjusting the asking price of at least one of the products.

8. The method of claim 7, further comprising the step of implementing the pre-defined and automated procedure for adjusting the asking price of at least one of the products only after the occurrence of a triggering event.

9. The method of claim 8, wherein the triggering event is the expiration of a pre-specified time period measured from a first date the at least one product was listed for sale on the e-commerce website.

10. The method of claim 7, wherein the pre-defined and automated procedure for adjusting the asking price results is a markdown of the asking price.

11. The method of claim 7, wherein the pre-defined and automated procedure for adjusting the asking price results in a markup of the asking price.

12. The method of claim 7, further comprising the step of storing an invoice price in the electronic storage medium.

13. The method of claim 12, wherein the asking price is based upon a markup of the invoice price.

14. The method of claim 7, further comprising the step of listing the at least one product for sale at the adjusted asking price.

15. The method of claim 7, further comprising the step of defining the pre-defined and automated procedure.

16. The method of claim 7, further comprising the step of providing a template to a seller to thereby allow the seller to define the pre-defined and automated procedure.

17. The method of claim 7, further comprising the step of receiving the pre-defined and automated procedure from a seller.

18. A method for offering products for sale on an e-commerce website, said method comprising the steps of:
storing product information regarding the products in an electronic storage medium, the product information identifying the products for sale and an asking price associated with each product;
listing the products for sale on the e-commerce website at their respective asking prices; and
notifying the seller with an electronic message that an offer has been made by a prospective buyer on a listed product.

19. The method of claim 18, wherein the electronic message is transmitted to the seller's cell phone.

20. The method of claim 19, wherein the electronic message is transmitted using short message service.

21. The method of claim 18, wherein information in the electronic message comprises contact information of the prospective buyer.

22. The method of claim 21, wherein information in the electronic message further comprises an offer price.

23. A computer system for operating an e-commerce website, said system comprising:
at least one computer comprising (1) an upload module for allowing a seller to upload product information, (2) a rule management module for allowing the seller to pre-define automated price adjustments for products listed on the e-commerce website, and (3) a pricing adjustment module for implementing the automated price adjustments defined by the seller.

24. The system of claim 23, further comprising a communication module for notifying the seller with an electronic message that an offer has been made by a prospective buyer on a listed product.

25. The system of claim 23, wherein the modules are implemented using computer programming.

26. The system of claim 23, wherein the at least one computer comprises a server.

27. A method for offering a product for sale on an e-commerce website, said method comprising the steps of:
offering the product at a price on the e-commerce website;
monitoring via a computer program a length of time that the product has been listed on the e-commerce website;
automatically adjusting via a computer program the price of the product to a new price based upon the length of time the product has been listed; and
offering the product at the new price on the e-commerce website.
